(19) United States
(12) Patent Application Publication
(10) Pub. No.: US 2014/0172596 A1
(43) Pub. Date: Jun. 19, 2014

(54) Assembly and Method of Handling Transactions

(71) Applicant: Eugene Raymond Ten Cate, Gouda (NL)

(72) Inventor: Eugene Raymond Ten Cate, Gouda (NL)

(73) Assignee: SEPASoft B.V., 'S-Hertogenbosch (NL)

(21) Appl. No.: 14/111,477

(22) PCT Filed: Apr. 16, 2012
(86) PCT No.: PCT/NL2012/050249

§ 371 Date: Jan. 30, 2014

(30) Foreign Application Priority Data
Apr. 14, 2011 (NL) 2006609

(51) Int. Cl. G06Q 20/20; G06Q 20/34; G06Q 20/02

(52) U.S. Cl. CPC G06Q 20/20; G06Q 20/202; G06Q 20/02; G06Q 20/341
USPC 705/16; 705/21; 705/18

(57) ABSTRACT

The invention relates to an assembly for handling transactions between a merchant and a consumer, comprising: —a cash register for generating and sending invoice data representative of the one or more products and/or one or more services relating to a transaction; —at least one payment terminal for generating and sending an electronic transaction order; —a payment system for electronic transfer of the transaction amount from the bank account of the consumer to the bank account of the merchant; —a transaction order processor for electronic clearing and settlement of the transaction amount associated with the transaction order, —a payment management system adapted to receive the invoice data and the electronic transaction order and to store at least a part thereof on a storage medium, wherein the payment management system is further adapted to control a transaction order processor in order to perform the transaction on the payment system.

The present invention relates to an assembly for handling transactions between at least one merchant and at least one consumer. The invention also relates to the payment management system of said assembly and to a method for handling such transactions.

For handling electronic transactions between a consumer and a merchant, (for instance a retailer) use is made of a system which is made up of inter alia a number of point of payment terminals, for instance a Point of Sale (POS) terminal, a number of banks and a transaction order processor which controls the electronic clearing and settlement of the transaction amount with the relevant banks. In general these systems are regionally oriented; each country has for instance its own transaction order processor and many of the banks involved are only operational in one or a limited number of countries.

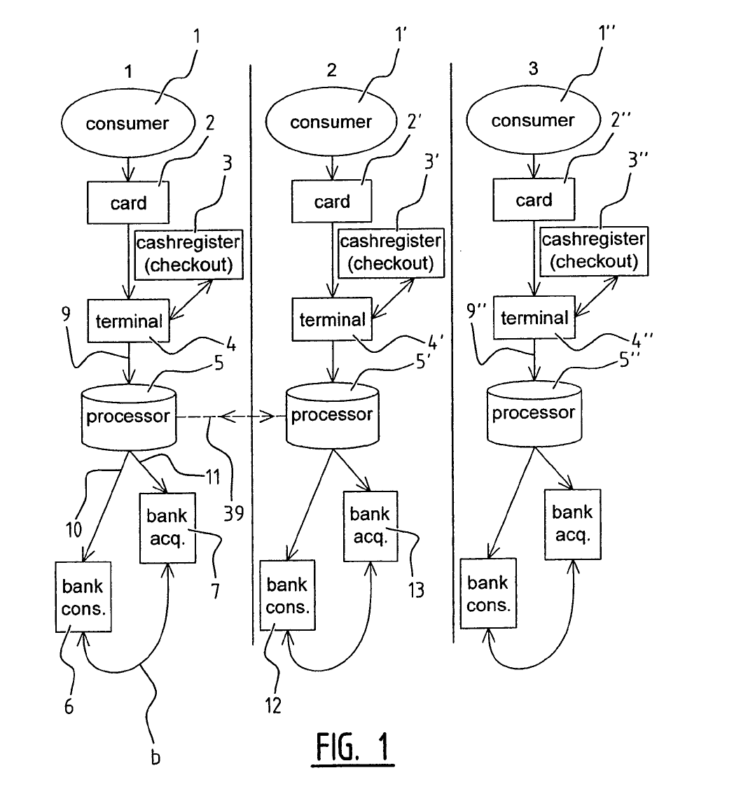

Shown schematically in FIG. 1 is a typical setup of such a system. The system is set up per region. The example shows only three regions (R1, R2 and R3), but this number can of course vary. When consumer 1 in the first region (R1) wishes to make a payment using his/her payment card 2 for the purchase of a product in a shop, the consumer inserts the card 2 into a payment terminal 4. The payment terminal disposed in the shop allows payments to be made according to one or more specific card schemes or card protocols. The terminal can optionally be coupled electronically to a cash register 3 which performs a part of the payment process. When the consumer 1 authorizes a payment, for instance by allowing his/her payment card to be read and entering a personal identification number (PIN) via a keyboard on the payment terminal, the payment terminal 4 generates an electronic transaction order. The payment terminal forwards the transaction order via a secure connection 9 to a so-called transaction order processor 5, also referred to here as the processor. This processor is in turn connected via secure connections 10 and 11 to a payment system. In the shown example the payment system comprises an issuer bank 6 and an acquirer bank 7. The transaction order now ensures that the transaction amount is debited from the account of the consumer at the issuer bank 6 and is credited (b) to the account of the merchant at the acquirer bank 7. A merchant in a specific area does not have a free choice of processor. The area in which the merchant is located determines the processor 5 (and thereby also the banks) with which the merchant has to do business.

The transaction order processor 5, more specifically the server handling the electronic transactions with the affiliated banks, and the payment system (i.e. the banks) normally operate in a limited geographical area. Banks within this limited geographical area have agreed to perform all their payment transfers via one central transaction order processor 5 and the merchants in this limited geographical area are obliged to work with payment terminals which have a one on one relation with said processor. It is therefore not possible for a merchant to personally select the processor handling the payment transfers. In the case of payments between various such geographical areas, for instance between the first region (R1) and the second region (R2), the processor 5 of the one area makes contact via a communication connection 39 with a processor 5′ in the other area and the handling of the transaction is provided by two (of more) processors 5 and 5′. Nor does the merchant therefore have any freedom of choice in respect of the processor of the second area (R2). This lack of freedom of choice is often not advantageous for the merchant for competitive reasons.

When the merchant, for instance a retailer, moreover has shops in various of such geographical areas (R1, R2, R3), he/she has to have contracts with the acquirer banks 7 so as to be able to make use of their services and with the associated processor 5 so as to make use of the payment terminal determined by processor 5. For a store chain with shops in two or more different regions contracts must therefore be concluded with different processors and banks to enable payments with the payment terminals in all these areas. The result hereof is that such store chains have to make extra costs. They often also need several regional bank accounts to be able to receive their payments, this resulting in inefficiencies in the management of cash flows of the merchants. It is further the case that each processor employs its own handling protocol and moreover prescribes which types of payment terminal may be used by the merchant. Processors in different countries may employ differing protocols and regulations here, so that the merchant must apply different types of payment terminal and/or different financial software for each country.

A further drawback is that the merchant is provided via the payment system which has performed the transaction with statements of the transaction amounts received by the relevant merchant. These statements comprise information concerning the final amount of the transaction, but other detail information, such as an indication of which products and/or services have been purchased, do not appear on these statements.

It is the object of the present invention to provide a system and method wherein at least some of the above stated and/or other drawbacks of the prior art are obviated or at least reduced.

Provided according to a first aspect of the present invention for the purpose of achieving at least one of the objects is an assembly for handling transactions between at least one merchant and at least one consumer, the assembly comprising:

a cash register, in particular an Electronic Cash Register (ECR), for generating and sending invoice data representative of the one or more products and/or one or more services relating to a transaction;

at least one payment terminal for generating and sending an electronic transaction order;

a payment system for electronic transfer of the transaction amount from the bank account of the consumer to the bank account of the merchant;

a transaction order processor connected to the payment system for electronic clearing and settlement of the transaction amount associated with the transaction order, wherein a payment management system (PMS) is arranged between the payment terminal and the transaction order processor which is adapted to receive the invoice data and the electronic transaction order and to store at least a part thereof on a storage medium, wherein the payment management system is further adapted to control a transaction order processor in order to perform the transaction on the payment system.

A link is hereby realized between the invoice data and a (financial) transaction actually realized by the payment system. This link can be used for numerous purposes. It is for instance possible to gain detailed insight into the transactions performed by a determined merchant. Certainly when the payment management system is utilized to control two or more processors which provide for the transactions in different countries, it is possible in simple manner to generate statements for all transactions performed in the different countries for a determined merchant.

According to an embodiment, the transaction order comprises at least one of the following data:
first transaction data representative of the transaction amount;
second transaction data representative of the transaction method;
third transaction data representative of the first identification data relating to the bank account number of the consumer;
fourth transaction data representative of the second identification data relating to the identity of the consumer.

According to a further embodiment, the first identification data are formed by data representative of the bank account number of the consumer, particularly in the form of the primary account number (PAN), and/or the second identification data are formed by data representative of the identity of the consumer, particularly in the form of a personal identification number (PIN).

It is noted that the authentication of the transactions continues to be performed by a transaction order processor itself. The usually secret identification data and identification protocols can thus remain within the domain of the transaction order processor (for instance a card issuer).

According to embodiments of the invention, the transaction order processor is adapted to perform authentication of the received transaction order, in particular of the first and second transaction data described herein. The payment management system can for instance be linked as virtual payment terminal to a transaction order processor. The usual authentication steps, for instance checking identification data such as the PAN and PIN data of a card, are performed by the transaction order processor itself, optionally supplemented by an authentication by the payment terminal. In determined embodiments the payment management system does not perform authentication of these identification data (e.g. PIN and PAN data).

The transaction order processor subsequently sends an authentication signal to the payment management system which is representative of the approval or rejection of the transaction.

The assembly preferably comprises of:

storing on a storage medium of the payment management system (PMS) a transaction certificate (TC) for each of the performed transactions, wherein the transaction certificate comprises merchant-specific identification data concerning the relevant transaction.

TCs can for instance be stored in a transaction database so that all data relevant to the transaction are easily accessible later.

According to an embodiment, the assembly comprises a communication unit (merchant portal) linked to the storage medium for providing external access to one or more of the transaction certificates (TCs).

According to another aspect of the invention, a system is provided for performing a multiple authentication for a transaction between at least one merchant and at least one consumer, the system comprising:

a payment management system adapted to receive a first authentication signal representative of the result of a first authentication step on the basis of the PIN and PAN codes of the consumer, and to receive a second authentication signal representative of the telephone number of the consumer;

wherein the payment management system (PMS) further comprises a storage medium on which telephone data are prestored, and wherein the payment management system (PMS) is further adapted to perform a second authentication step on the basis of the second signal and the telephone data prestored on the storage medium.

The telephone data can for instance comprise the telephone numbers associated with the EMV SIM elements for which transactions are permitted (or conversely not permitted). An additional authentication of the transaction can in this way be realized, this enhancing the security of the transaction.

According to an embodiment of the invention, the system comprises a payment terminal provided with:

a reader for reading both the PAN code and data relating to the telephone number associated with an EMV SIM element in the mobile phone of the consumer;

a keyboard for receiving the PIN code of the consumer.

According to another aspect of the invention, a system is provided for handling transactions between at least one merchant and at least one consumer, the system comprising:

at least one payment terminal for generating and sending an electronic transaction order, the transaction order at least comprising the transaction amount, first identification data relating to the bank account number of the consumer and second identification data relating to the identity of the consumer;

a payment system for electronic transfer of the transaction amount from the bank account of the consumer to the bank account of the merchant;

a transaction order processor connected to the payment system for electronic clearing and settlement of the transaction amount associated with the transaction order, wherein the processor is adapted to perform an authentication on the basis of the first and second identification data and to generate a first authentication signal representative of the result of the authentication;

a payment management system (PMS) arranged between the payment terminal and the transaction order processor and comprising a storage medium on which telephone data are stored, wherein the payment management system is adapted:

to receive a first authentication signal representative of the result of a first authentication step on the basis of the first and second identification data of the consumer; and

to receive a second authentication signal representative of the telephone number of the consumer;
to perform a second authentication step on the basis of the second authentication signal and the telephone data prestored on the storage medium.

In determined embodiments the payment management system (PMS) can form a virtual payment terminal. Instead of being connected via a communication connection to a physical payment terminal, a transaction order processor can be connected via the communication connection to a virtual payment terminal in the form of the payment management system. The transaction order processor thinks there is a connection to the physical payment terminal and does not in principle need to notice that there is in reality only a connection to the payment management system. This means that in determined embodiments there is no hardware and/or software modification of the transaction order processors required at all, or at least hardly any.

A payment system can be made up of at least one issuer bank subsystem which manages the bank account of the consumer and an acquirer bank subsystem which manages the bank account of the merchant. The transaction order processor is adapted here to control both subsystems for the purpose of transferring an amount of money from the issuer bank subsystem to the acquirer bank subsystem. When there are two or more different payment systems, according to an embodiment of the invention the payment management system (PMS) can be adapted to select one of the payment systems. This can for instance be realized by selecting one of the transaction order processors which are linked to the selected payment system. According to determined embodiments of the invention, a free bank choice can in principle hereby be realized.

Arranged between the payment terminal and the payment management system, between the payment management system and each of the transaction order processors, and between the transaction order processors and payment systems (banks) are communication connections which enable a preferably secure mutual data communication.

According to an embodiment of the invention, the payment terminal is adapted to generate and send information concerning the transaction order processor to be selected and/or concerning the payment system to be selected. This information can for instance be formed by an application identifier (ApID). Such an application identifier is representative of the application (e.g. payment product or payment method) used for paying. In determined embodiments the application identifier also determines the acquirer identifier (AID) of the acquiring bank which is going to perform the transaction.

The payment management system (PMS) can further be adapted to receive this information and, on the basis of the received information, to select the transaction order processor which must control the payment system and/or the payment system which must perform the transaction. At the instruction of for instance the merchant and/or the consumer, information can be generated on the payment terminal which influences or even determines the selection of the transaction order processor.

The payment terminal is preferably adapted to encrypt at least one (but still more preferably all) of the first, second, third and fourth transaction data. In a particularly advantageous embodiment the encryption is performed before sending to the payment management system (PMS) and/or before storing thereof on the payment terminal or on the PMS.

In determined embodiments the system comprises a wireless receiver for reading a smart card via a wireless connection. A standard for contactless cards is formed for instance by ISO/IEC 14443. Use can for instance be made of a mobile telephone smart card, more particularly an EMV SIM card.

According to a further embodiment the payment management system (PMS) comprises a storage medium and the system is adapted to store a transaction certificate (TC) for each of the performed transactions, wherein the transaction certificate comprises merchant-specific identification data concerning the relevant transaction. This merchant-specific information can for instance comprise an invoice reference (number), a specification (text), an order number, an official report and the like. The merchant-specific information can now be linked directly to actually performed past transactions. In determined embodiments it is made possible for the merchant (for instance via a so-called merchant portal) to log into the payment management system (PMS) and thus gain access to (a part of) the stored data, for instance in the case of an exchange for checking merchant-specific information stored on the storage medium in the form of an invoice. In addition to the merchant-specific information, the stored data can at least comprise one of the following data:
first transaction data representative of the transaction amount;
second transaction data representative of the transaction method;

third transaction data representative of the first identification data;
fourth transaction data representative of the second identification data;
the terminal identifier (TID); and/or
the merchant identifier (MID).

The financial management of the merchant and the monitoring thereof can hereby be greatly simplified. When for instance the TID is stored in combination with a transaction, it is possible at a later stage to collect and to analyse transaction-related details per payment terminal (or per group of payment terminals, for instance a number of payment terminals disposed in a determined shop).

According to another aspect of the invention, a method is provided for handling transactions.

Further advantages, features and details of the present invention will be elucidated on the basis of the following description of some embodiments thereof. Reference is made in the following description to the figures, in which:

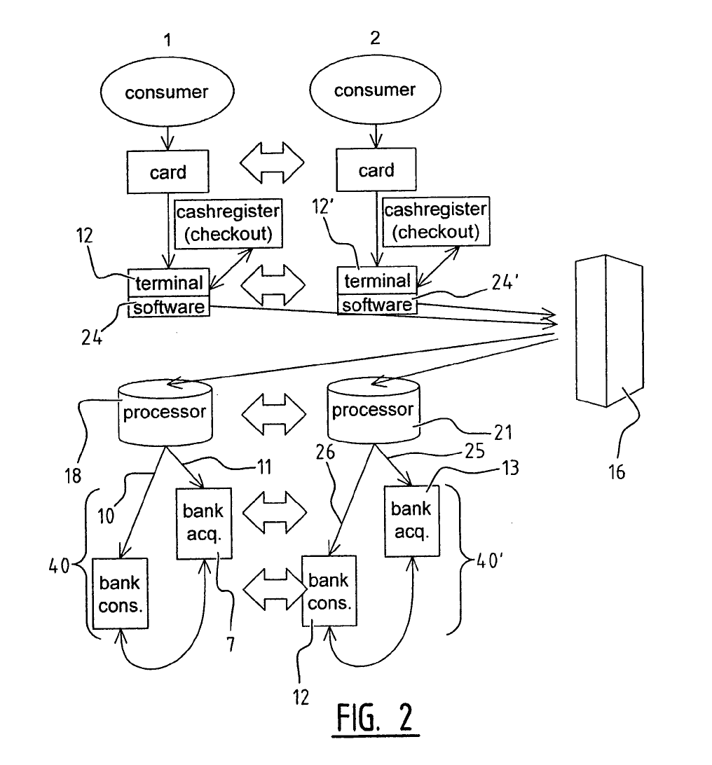

FIG. 2 shows a schematic overview of a first embodiment of a system according to the invention;

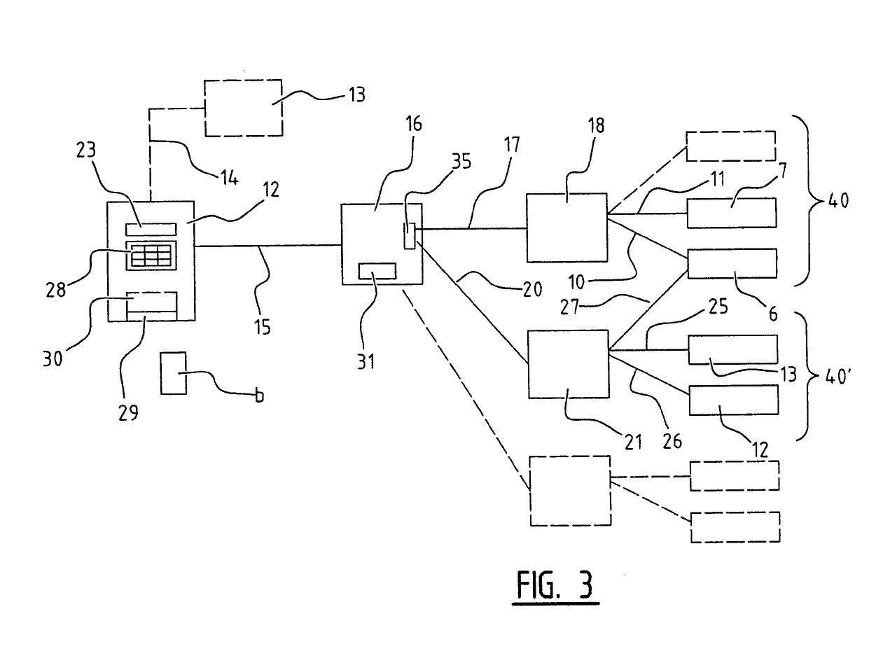

FIG. 3 shows a more detailed overview of the embodiment of FIG. 2;

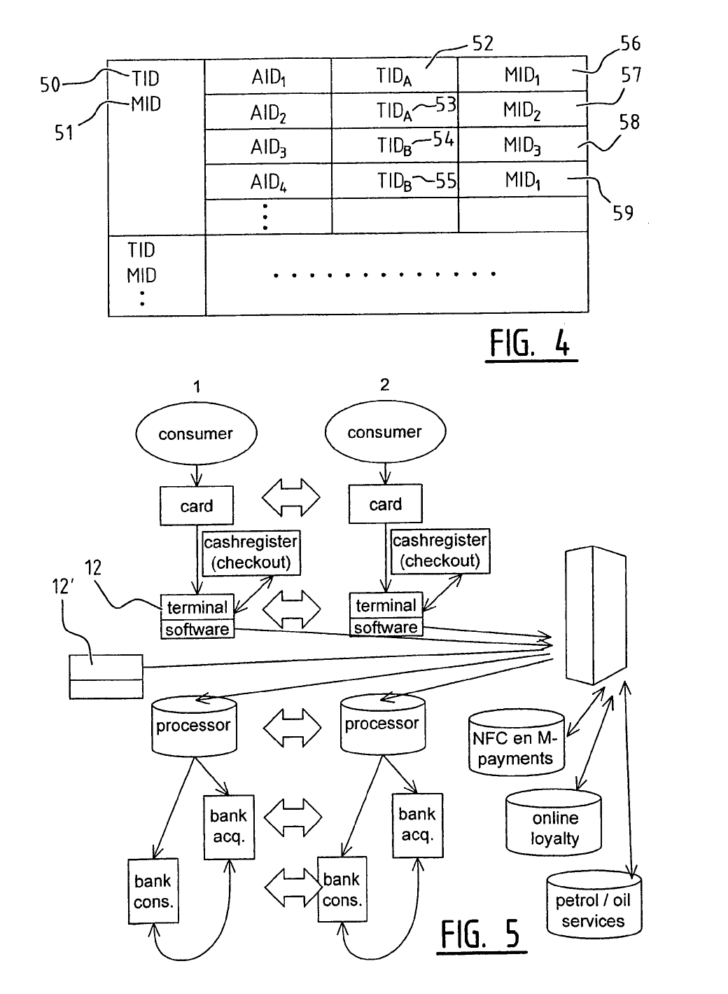

FIG. 4 shows schematically the information stored on the storage medium of the payment management system;

FIG. 5 shows a schematic overview of a second embodiment of a system according to the invention;

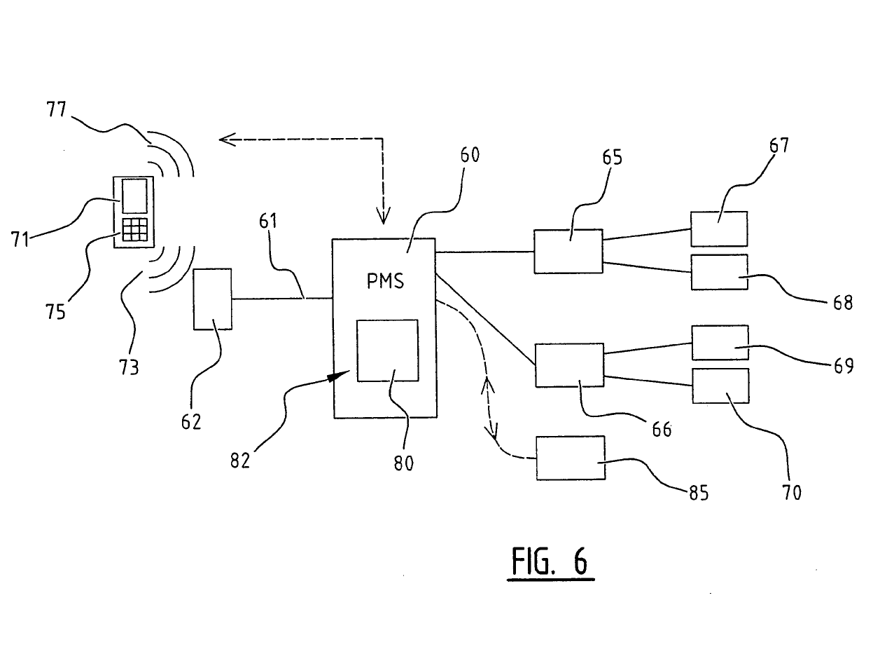

FIG. 6 shows a schematic overview of a third embodiment of a system according to the invention;

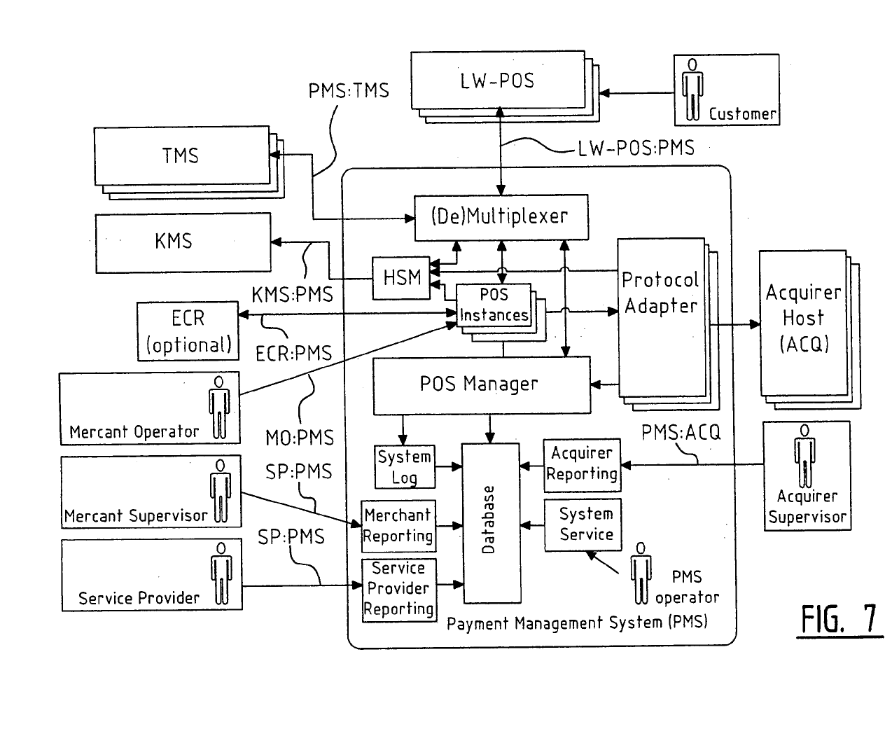

FIG. 7 shows a more detailed diagram of the payment management system according to an embodiment of the invention.

An embodiment of the present invention is shown in FIG. 2 and, in more detail, in FIG. 3. FIGS. 2 and 3 show two payment systems. The first payment system 40 is located in the first region or the first area (R1), while the second payment system 40′ is located in the second area (R2). Each of the payment systems comprises a number of servers with which the banks connected to the payment system can perform their mutual payments. The first payment system 40 comprises a server 6 of an issuer bank, i.e. the bank at which the consumer holds an account, and a server 7 of an acquirer bank, i.e. the bank where the merchant holds his/her account. The servers are mutually linked via one or more communication networks. In practice there will usually be more than two servers, so that payment system 40 is suitable for making payments at each of the banks in the relevant area. The payment systems are connected via respective secure connections 10,11 to a first transaction order processor, also referred to in the field as the processor 18. This processor is adapted to control servers 6,7 of the payment system 11, i.e. to perform the required transactions. Instead of the processor being directly connected to one or more payment terminals as shown in FIG. 1, according to an embodiment of the invention processor 18 is connected via a secure connection 17 to a payment management system 16. The payment management system is also referred to here as the PMS system, PMS server or simply PMS. The payment management system is embodied such that it can control the above mentioned payment systems to perform a determined transaction. It is noted here that the payment in the payment management system stands for a transaction representing a determined value, of a financial or non-financial nature. Payment management system 16 is further connected with a secure connection 15 to one or more payment terminals 12.

A transaction order processor or processor 21 is provided in usual manner for the purpose of handling transactions in the second area (R2). According to the shown embodiment of the invention however, payment management server 16 is also connected via a secure connection 20 to one or more further transaction order processors, such as the second transaction order processor or processor 21 shown in the figure.

Second processor 21 is connected in similar manner using secure connections 25, 26 to respective servers of second payment system 40′. Second payment system 40′ consists in the shown embodiments of a server of an issuer bank 12 and a corresponding server of an acquirer bank 13, mutually connected via one or more electronic communication networks. It is noted that in other embodiments many more banks are linked to the second processor 21. It will further be apparent that the role played by a determined bank can change. On one occasion a bank forms the issuer bank, since the bank account of the consumer is registered at this bank, on another occasion it forms the acquirer bank because in this case the bank account of the merchant is registered at this bank. It is also possible for both the merchant and the consumer to have their bank account at the same bank.

Further shown in FIGS. 2 and 3 is that second processor 21 can be connected not only to second payment system 40′ of the second area (R2) but can also be linked, for instance via a secure connection 27, to one or more banks of first payment system 40 located in the first area (R1).

While in FIGS. 2 and 3 there are two processors 18, 21 which are together connected to a single server of payment management system 16, this number can of course vary in accordance with the number of different processors in the overall area in which the transactions must be realized.

Payment terminal 12 is provided in usual manner with a slot 29 into which a bank card (B) can be inserted such that the magnetic strip or EMV chip © present on the bank card (B) can be read by a reader 30 arranged in terminal 12. Payment terminal 12 is also provided with, among other components, a keyboard 28 with which the user can enter his/her PIN code and a display 23 on which texts, such as the transaction amount, can be displayed.

In determined embodiments, for instance the embodiment as shown in FIG. 3, payment terminal 12 is also linked via a connection 14 to a cash register 13, for instance an electronic cash register (ECR). This cash register can for instance send a signal to payment terminal 12 from which the payment terminal 12 can derive the amount to be paid. In other embodiments payment terminal 12 is however embodied as stand-alone device and the amount has to be entered via the keyboard 28 of the terminal 12 itself.

In the configuration phase, in which a number of computer programs 24,24′ are loaded and installed onto payment terminals 12,12′ from the payment management system or PMS system 16, a connected payment terminal is assigned a unique code from PMS system 16. This code, also referred to as the terminal identifier (TID), is stored on storage medium 31 of PMS system 16 as a master TID 50, as shown in more detail in FIG. 4, and is used by PMS 16 to identify the relevant payment terminal.

A unique code or identifier can be assigned in similar manner to the merchant associated with payment terminal 12, i.e. for instance the retailer in whose shop the payment terminal is disposed. The assignment of this code is carried out by the acquirer bank with which the merchant has a contract. This identifier, also referred to as the master merchant identifier MID 51, is likewise stored on storage medium 31 of PMS system 16 in the above stated configuration phase.

In the configuration phase the payment terminal 12, more particularly the representative master TID 50, is further linked to one or more corresponding codes (derived or slave TIDs 52,53) with which the payment terminal is designated by the different processors 18,21. The payment terminal 12 identified using a master TID 50 has for instance a determined unique first terminal identifier TID_{A} 52,53 (FIG. 4) for first processor 18 and a determined unique second terminal identifier TID_{A} 54,55 for second processor 21.

The merchant designated with the master MID 51 can be designated in similar manner with different slave MIDs. The merchant does after all have different contracts at the different banks for the handling of the payment transfers. The merchant can be assigned different MIDs at the banks. Stored on storage medium 31 of PMS server 16 are the master MID 51, the slave MIDs 56-59 and the relations existing between them.

In the shown example the acquiring bank 7 has for instance a contract with the merchant of payment terminal 12 and this merchant has obtained the unique merchant identifier (MID) 56. The same merchant has been given another unique identifier from another bank 13, for instance merchant identifier MID 57. Both identifiers MID 56,57 therefore designate the same merchant, but can relate to different handling protocols. In similar manner the bank 13, which is also connected to second processor 21, can have designated the same merchant with a third merchant identifier MID 58.

Via the table stored on storage medium 31 (FIG. 4) it is thus possible in each case to find the relation between on the one hand the merchant and/or payment terminal with which the transaction is requested, and on the other the respective processor and/or bank (in particular the acquiring bank) with which the transaction can be performed. In other words, processor 18 can communicate with PMS 16 as if it were the payment terminal 12 itself. The same applies for second processor 21. Second processor 21 can also communicate with PMS 16 as if it were the payment terminal 12 itself. PMS 16 therefore functions here as a kind of virtual payment terminal arranged between the physical payment terminal 12 and processor 18, 21. Modifications to the hardware and/or software of the processors are in principle therefore not necessary to enable control of the transaction.

When a consumer wishes to carry out a transaction in the user phase (following the above stated configuration phase), he/she places the card (B) into the slot of payment terminal 12. Reader 30 reads a number of data from the card in usual manner. Payment terminal 12 more particularly recognizes that a card has been inserted into the terminal via the Client software running on the payment terminal.

A part of the data read by the payment terminal is formed by the so-called application identifier (AID). Described in the above mentioned ISO/IEC standard 7816 is the process for the selection of the different applications supported by the card. Applications can refer here to wholly differing applications such as GSM and EMV, although an application can also be a product type supported by a determined product issuer (e.g. banks issuing a Visa, Mastercard, etc.). The product issuer of a Visa card may support different applications, such as Visa credit/debit, Visa Electron, V PAY, etc., while the product issuer of a MasterCard card may support the applications credit/debit, Maestro, Cirrus, etc. Each product issuer has in general one or more of its own product types or applications. In order to enable selection of an application use is made of the above mentioned application identifier (AID). An AID consists of a registered application provider identifier (RID), which is issued by the standardization organization and which designates the relevant product issuer in unique manner, as well as a proprietary application identifier extension (PIX) to enable differentiation in unique manner within the product types or applications supported by the product issuer. The AID thus designates both the product issuer (Visa, MasterCard, etc.) and the associated product type (Visa credit debit, V PAY, Cirrus, etc.).

The Client software running on the payment terminal controls the reader such that the card is read. The reader reads from the card the possible card payment applications (Application ID of the card). This produces a list consisting of one or more possible application IDs for the card. This card application ID list is subsequently compared by the payment terminal to a prestored list on the payment terminal (consisting of one or more IDs) of applications supported by the payment terminal.

If no match is found between the card ApIDs and payment terminal AIDs, a message is sent back via the display of the payment terminal that payment has to be made in another way. In the case of a match the consumer is provided with the option of selecting one of the possible card application IDs (i.e. one of the card ApIDs for which a match has been found). The selected ApID is subsequently incorporated in an electronic payment order, for instance in the form of transaction data, as described in more detail below.

In addition to the application identifier (ApID) defining the product issuer and product type/application, other data is read such as the PAN code. PAN stands for Primary Account Number, i.e. the bank account number of the card holder, more particularly the bank account number of the consumer. Via keyboard 28 and/or via cash register 13 the amount to be paid is subsequently displayed on display 23. The consumer can then give his consent and enter the personal identification code (i.e. the PIN code (PIN)) unique to the consumer.

Payment terminal 12 collects the PAN and PIN codes, encrypts them and sends them, together with transaction data representative of the transaction amount and the transaction data representative of the desired application (the AplD data), to PMS 16.

PMS 16 determines on the basis of the received ApID data designating the desired application (for instance the Visa VPAY application) (and optionally the master TID 50 and master MID 51 already stored in the configuration phase) which of the processors 18,21 should be selected to handle the transaction. A determined processor is for instance adapted to process VISA VPAY transactions, while yet another processor is adapted to process Mastercard credit/debit transactions. The choice of the processor can likewise depend on the area in which the payment terminal is situated (which area can be derived from the TID of the payment terminal stored in the configuration phase, since the area in which the payment terminal is situated is known beforehand) and/or on the issuer bank which must ultimately perform the transaction (which bank can be derived from the PAN data of the consumer).

In a determined exemplary embodiment tables are stored on PMS 16, at least in the electronic storage medium connected thereto, on the basis of which a number of possible methods of payment can be selected in accordance with the ApID data for each payment terminal (i.e. for each master TID 50). When for instance the received ApID data correspond to AID₁, the transaction will be handled by first processor 18 together with issuing bank 6 of payment system 40. The payment terminal has a TID 52 in first processor 18 and the merchant has a MID 56. When the AID data correspond to AID₂, the transaction will be performed by the same processor 18, but the transfer of amounts takes place via one or more other banks, for which the merchant is designated with the unique designation MID₂. When the AID data correspond to AID₃, use is however made of second processor 21 (wherein the payment terminal is designated in unique manner with TID_{B}) and a further acquirer bank 13 in which the merchant is designated with MID₃. Finally, when the AID data correspond to AID₄, second processor 21 will be used while a bank from the first payment system 11 will perform the actual transaction. The merchant is again characterized here by MID₁ 59.

Once processor 18, 21 has been chosen with which the payment is controlled and the acquirers, in particular the acquiring bank 21, 23 have moreover been selected in the above described manner, a transaction order is generated in a so-called protocol adapter 35 of PMS 16 in accordance with the relevant protocol for the associated processor 18, 21 and the associated acquirers. A transaction signal is then sent to the relevant processor 18,21 in accordance with the generated transaction order, which further handles the transaction in the usual manner.

The application ID (ApID, sometimes also abbreviated to AID) received from the payment terminal is more particularly associated with a specific acquiring zone. The acquiring zone is related to a determined processor and to the associated Acquirers (acquiring and issuing banks). Each processor has its own application ApID and several Acquirers, each employing their own MIDs, are active within this environment.

PMS 16 subsequently links the application identifier (ApID) received from the payment terminal to the correct acquirer zone. Found within the linked acquirer zone is the associated acquirer identifier (AID) of the processor associated with the relevant payment method, and the communication with the processor is started for the purpose of handling the payment transaction via the selected payment method.

The processor here sends the transaction data over the communication network to the issuing and acquiring banks relevant for authorization of the PIN associated with a specific PAN and transaction amount, including all transaction data between card and payment terminal. The processor receives a response from the issuer that the authorization of both is accepted and the transaction amount is reserved at the acquirer bank. An authorization code is sent back to the payment terminal and linked to a transaction certificate (TC) which is associated with the relevant payment and is stored as such. This communication between processor 18,21 on the one hand and the issuer and acquirer banks on the other is known in the field under the terms clearing and settlement. The communication can take place online and/or offline.

It is thus possible to ensure in the above described manner, simply by also sending a preference via the AID data, that the merchant him/herself can determine via which route (processor/acquirer) the transaction is handled.

Because PMS server 16 is as it were placed as virtual payment terminal between the physical payment terminal 12 and processors 18, 21, there is also a greater freedom of choice for the merchant in the selection of the desired type of payment terminal. Where according to the prior art the types of payment terminal to be used were determined by the requirements set by the relevant processor 18, according to embodiments of the invention the PMS 16 can be adapted such that different types of payment terminal (not the type of payment terminal prescribed by the relevant processor) can be used as long as PMS 16 is capable of making the correct translation so as to enable processor 18, 21 to be controlled in the desired manner (as if it were being controlled by a prescribed payment terminal).

Shown for instance in FIG. 5 is a further embodiment of the invention which largely corresponds to the embodiment shown in FIG. 2, but wherein more than one payment terminal is linked to PMS 16. In addition to the above mentioned payment terminal 12 of a first type, in the shown embodiment a second payment terminal 12′ is linked of another type differing from the above mentioned type. Because PMS 16 is adapted to make a correct translation of the signals coming from the different types of payment terminal to the format suitable for the relevant processor 18, 21, according to the embodiment of the invention the merchant him/herself can choose the type of payment terminal (12, 12′) he/she will use to perform the transactions.

In a further embodiment PMS 16 is adapted to handle not only financial transactions but also non-financial transactions, for instance transactions related to loyalty cards, bonus cards, etc. In these embodiments contact is made with PMS 16 by payment terminal 12. On the basis of the provided PAN codes, after a possible authentication step, PMS 16 can store information about the relevant consumer on storage medium 31 of PMS 16. This information can for instance comprise loyalty information, for instance data received from the cash register system which are representative of the articles purchased by the consumer. This loyalty information can for instance be used to give discount on possible further financial transactions.

In determined embodiments use is made by the system of only the PAN data (and not also the PIN data). The PAN data can be stored on the magnetic strip of the electronic input carrier. On the basis of the PAN data (and so without requiring a PIN code) the card can be recognized via BIN from the CST (Card System Table) as being a loyalty card. In consultation with an acquirer bank a determined card range can even be reserved for loyalty purposes. The card data can subsequently be sent directly to the loyalty host and processed and, if desired or supported, linked to the financial transaction and the associated transaction amount. Value points can in this way be saved or redeemed with the loyalty card. The loyalty host keeps track of the conversion rate and the balance total. Using this solution the retailer is able to influence the behaviour of the consumer. For instance 200 points if the consumer opts to pay with a first application (for instance Maestro) and only 50 points for paying with a second application (for instance with Visa or MasterCard credit cards).

In the embodiments of FIGS. 2-5 discussed up to this point the payment terminal 12, 12′ is coupled electronically to PMS server 16 via a wire connection. Communication connection 15 between payment terminal 12 and PMS server 16 forms a secure connection according to a predetermined protocol, for instance the transport layer security (TLS) or the secure socket layer (SSL) cryptographic protocol, so that secure data communication is realized over the electronic communication connection (in particular the internet). Further described up to this point is that the input carrier is a payment card, loyalty card or the like, wherein the data representative of the client, such as the PAN code, are stored on a magnetic strip or on a microchip (for instance an EMV chip). These cards can be read by placing the relevant card in a slot of the payment terminal or guiding it along a slot. There must in any case be some contact between the card and the payment terminal. In other embodiments however, the input carrier (card) can be read, for instance by detecting a bar code provided on the card by means of an optical bar code reader or by making use of an electromagnetic sensor for reading a resonance circuit (for instance an RFID tag or the like). In yet another embodiment use can be made of NFC technology, which is provided for instance on a mobile platform, such as a mobile phone, PDA or the like. An EMV functionality can for instance be arranged in the SIM card of the mobile phone so that reading the SIM card, or at least a part thereof, can be seen as a reading of the EMV chip used which is provided on a payment card.

FIG. 6 shows an example of performing a financial transaction remotely using a mobile platform. Shown in the figure is a PMS server 60 which is connected in known manner via a secure data connection 61 to a payment terminal 62. PMS server 60 is further linked in the above described manner to one or more processors 65,66 which in turn control one or more transaction systems (acquirers) 67-70. Further shown is a mobile phone 71 which establishes a wireless connection 73 to payment terminal 62 using an NFC transmitter/receiver. Because the smart card (SIM card) provided in the mobile phone is provided with EMV functionality, it is possible to have the mobile phone 71 function as a payment terminal. In similar manner as described above, payment terminal 62 reads the mobile phone (payment card) and here collects inter alia the PIN code unique to the consumer and the PAN code representative of the bank account of the user.

In order to provide extra security, mobile phone 71 makes contact via a wireless network transmitter/receiver 75 with the mobile network (for instance a GSM network, 3G network, etc.) and establishes an internet connection 77 with PMS server 60. When the Internet connection is made between phone 71 and PMS server 60, PMS server 60 can determine the mobile phone number (M) of the phone 71 (with a standard number recognition technique). This mobile telephone number (M) can subsequently be compared to a list 80 of prestored mobile phone numbers (M₁-Mₙ). Mobile phone numbers can be stored on PMS server 60 or, as in the shown embodiment, on a separate storage medium 82. The list of telephone numbers 80 originates from the mobile network operator (MNO) managing the network with which the Internet connection has been made. PMS 60 can for this purpose be directly connected to a server 85 of the mobile network operator (MNO). In addition to the check of the PIN and PAN code via processor 65,66 and the payment systems of the bank, an additional check can thus be performed by comparing the telephone number of the consumer with a list of prestored telephone numbers of the mobile network operator (MNO). When the telephone number of the mobile phone is not stored in the list 80 for the storage medium 82, in a determined embodiment the PMS can conclude that the transaction is not allowed to take place. In another embodiment the PMS 60 will however decide that a transaction is allowed to take place, but that this transaction has a higher risk profile. Depending on the size of the amount and possible other parameters, it is then possible for instance to decide to allow the transaction to continue, but at relatively high costs.

A more detailed description of the specific embodiment for handling transactions is given hereinbelow.

Table 1 gives an explanation of different components of the transaction system according to an embodiment of the invention. Reference is made in the table to FIG. 7 in which a more detailed diagram of the PMS system is shown.

TABLE 1

| | |
|---|---|
| 16 | Payment management system |
| | PMS: the central software core on the central host |
| | system which has control over the payment logic and |
| | controls the hardware |
| 12 | Input hardware device: the input hardware which |
| | comprises the readers (readers for smart card, magnetic |
| | strips, NFC, RFID, bar code) which can read the required |
| | input data. The input hardware has to comply with the |
| | general requirements of the Payments Card Industry (PCI) |
| | standards: PCI PTS (PIN Transaction Security devices = |
| | PTS). This means that the hardware must be secured in |
| | order to secure the input data. |
| 13 | Electronic Cash Register (ECR): the interface of the ECT |
| | system of the merchant which also provides data input to |
| | the PMS system. The ECR interface has the option of |
| | linking a unique merchant identifier to the transaction |
| | data. |
| 40 | Acquirer hosts: the host systems of the processors. The |
| | processor controls the processing of clearing and |
| | settlement files between the acquiring banks and the |
| | issuing banks. In other words they provide for the |
| | mechanism in which the transaction amount to be paid by |
| | the consumer at the POS in the shop of the merchant is |
| | transferred in electronic manner from the bank account |
| | of the consumer to the bank account of the merchant. |
| 1 | Consumer: the person starting the electronic transaction |
| | at the POS (including e.g. a physical payment terminal |
| | or a webshop or the like) in order to obtain goods or |
| | services in exchange for money or for a value transfer |
| | accepted in similar manner. |
| | Merchant is for instance the retailer (organization or |
| | person) accepting electronic payments in the virtual |
| | and/or physical shop(s) |
| 013 | Terminal Management System: the TMS (terminal management |
| | system) subsystem provides for the remote configuration |
| | and secure software and firmware downloads of the input |
| | hardware. The Client profiles (behaviour of the input |
| | hardware on the input products: how for instance does |
| | the payment terminal deal with the EMV payment cards |
| | that are used, risk management) are exported from the |
| | PMS to the TMS system and subsequently configured for |
| | the specific type of input hardware. |
| 014 | Key Management System: The Key Management System (KMS) |
| | controls all keys in the PMS. The KMS is used to create, |
| | store, import, export, store and use as back-up the keys |
| | of the POS terminals, OMS, TMS, third-party systems and |
| | the like in secure manner. |
| 021 | The DeMultiplexer: The (De)Multiplexer has the task of |
| | routing messages as follows: |
| | routes TMS messages from the TMS to the correct LW- |
| | POS; |
| | routes TMS messages from the LW-POS to the TMS; |
| | routes PMS messages from the LW-POS to the correct POS |
| | instance; |
| | routes PMS messages from the POS instance to the |
| | correct LW-POS. |
| 023 | POS instances: as mentioned above, the architecture aims |
| | at offloading complexity from the LW-POS or input |
| | hardware device to the PMS. The LW-POS communicates with |
| | a counterpart in the PMS referred to as the POS instance |
| | or virtual POS terminal. Every connected LW-POS has its |
| | own POS instance. The POS instance contains most of the |
| | payment flow and generates the content of host messages |
| | that are sent to the acquirer host via the protocol |
| | adaptor during a transaction. |
| 024 | Protocol adaptor: the protocol adaptor formats the host |
| | message in the correct format for the intended acquirer |
| | and adds the security to these messages (MAC, |
| | encryption, etc). The ability to switch between protocol |
| | adaptors enables switching between acquirers. |
| 025 | POS manager: the POS Manager manages all the POS |
| | instances in the PMS and connects them to the correct |
| | protocol adapter. The manager holds a POS profile with |
| | third party via trusted relations when an LW-POS is |
| | connected and disables them when an LW-POS is |
| | disconnected. The POS Manager also serves a role as |
| | overall guard. It will not allow unknown LW-POS |
| | instances to connect. |
| 026 | System log: the System Log module stores in the database |
| | all the log information used by the other modules in the |
| | PMS. This information can be used for analysis and |
| | debugging of the PMS system. |
| 027 | Database: all LW-POS or input hardware Client and POS |
| | profiles with configuration and trusted relations (who |
| | is the merchant of the LW-POS, who services the |
| | merchant, what cards can it accept, etc.) and all |
| | transaction results are stored in the database. |
| | The data in the database are used for the various |
| | reporting functions (Merchant reporting, Service |
| | Provider reporting and System reporting). |
| 028 | Merchant reporting: the configuration can be seen by the |
| | merchant. It also provides usage data per device and |
| | location. |
| 029 | Service Provider reporting: this is the location where a |
| | service provider can configure the input hardware and |
| | ECR device. It can also provide usage statistics for |
| | preventive maintenance. See 009. |
| 030 | Acquirer reporting: The acquirer can generate usage |
| | statistics. See 010. |
| 031 | System service: The Service console can be used to |
| | manage the configurations of the connected LW-POS |
| | terminals and other system settings. |
| 032 | PMS Operator: see 005 |

According to embodiments of the invention a method and system is provided for realizing freedom of choice in a flexible manner in the secure relations an electronic transaction system maintains with third parties. The electronic transactions processed via the system comprise data representing a specific value of a financial or non-financial nature. In the operational environment this value is accepted by all users as a valid electronic means of payment. Value is transferred in electronic manner from the one user to the other. At the beginning of the system the identity of the user is determined on the basis of a unique physical carrier and a unique code linked to this carrier. Linked to these two entities is a transaction amount which is exchanged with a third party which validates and approves the transfer of the value. In order to prevent fraud and manipulation the electronic transaction is preferably handled wholly within a secure environment. For this purpose the physical data of the carrier and the associated unique code are basically secured immediately at input, including the associated electronic value. The validation and the authorization of the value transfer via an encrypted and secure relation with a third party is subsequently realized and this results in a successful transfer. This all starts in a hardware input environment which is specifically designed for this purpose and complies with the international guidelines, standards and specifications (PCI PTS, EMV level 1 and 2, and SEPA FAST volume 1). In the classic traditional setup only one on one secure relations are possible between the input hardware and the relevant third party, wherein the third party imposes and determines the secure relation.

Some of the described embodiments make it possible to enter simultaneously into a plurality of secure relations with third parties, thus enabling the end user to make a choice from the diverse parties. In this case the input hardware determines with the security software with whom it maintains a secure relation by realizing the secure relations with the third parties from the input hardware. An important distinction is that the secure relation is reversed 180 degrees and is now set up from the end user with the associated preferred parties, and no longer the other way around.

The system enabling the freedom of choice comprises in determined embodiments a central secure software bus which has a number of specific branches for handling specific tasks. The front end software operating on the input hardware provides for the secure input, storage, output and communication. The central software likewise provides for the secure input, storage, output and communication. The difference here is that the central part fully controls and checks the front end. The principle of the Client-Server technology is applied for this purpose.

Immediately following input of a card (payment card, credit card, etc.) and of the PIN and PAN data the relevant data is encrypted via the Client software running on the payment terminal and thereby made inaccessible to the outside world. The encrypted data are then sent in tunnelled manner (via a secure connection) to the secure memory part of the payment management system (PMS). The PMS forwards these data (in a protocol selected from a list of possible protocols) in an authentication request via a secure connection to the selected transaction order processor. This processor subsequently performs a check (authentication), for instance on the authenticity of the card and on the PIN code. As supplement to this check the payment terminal can also perform a first check. In determined embodiments the authenticity of a card is checked in the first instance by the Client on the payment terminal. A PIN code can for instance be checked in an offline mode with the encrypted PIN on the card itself, and be directly validated and checked in an online mode by the card issuer (i.e. the transaction order processor) which has issued the relevant card. In both modes the PMS always submits an authentication request (also referred to as authorization request) to the card issuer(s). The identification data such as the PAN and PIN data are not saved or stored by the payment management system. The secrets of the card and associated PIN validation remain in the domain of the card issuers.

The present invention is not limited to the embodiments thereof described herein. The rights sought are defined by the following claims, within the scope of which numerous adjustments and modifications can be envisaged.

1. Assembly for handling transactions between at least one merchant and at least one consumer, the assembly comprising:
a cash register, in particular an Electronic Cash Register (ECR), for generating and sending invoice data representative of the one or more products and/or one or more services relating to a transaction;
at least one payment terminal for generating and sending an electronic transaction order;
a payment system for electronic transfer of the transaction amount from the bank account of the consumer to the bank account of the merchant; and
a transaction order processor connected to the payment system for electronic clearing and settlement of the transaction amount associated with the transaction order, wherein a payment management system (PMS) is arranged between the payment terminal and the transaction order processor which is adapted to receive the invoice data and the electronic transaction order and to store at least a part thereof on a storage medium, wherein the payment management system is further adapted to control a transaction order processor in order to perform the transaction on the payment system.

2. Assembly as claimed in claim 1, wherein the transaction order comprises at least one of the following data:
first transaction data representative of the transaction amount;
second transaction data representative of the transaction method;
third transaction data representative of the first identification data relating to the bank account number of the consumer;
fourth transaction data representative of the second identification data relating to the identity of the consumer.

3. Assembly as claimed in claim 2, wherein the first identification data are formed by data representative of the bank account number of the consumer, particularly in the form of the primary account number (PAN), and/or wherein the second identification data are formed by data representative of the identity of the consumer, particularly in the form of a personal identification number (PIN).

4. Assembly as claimed in claim 1, wherein the transaction order processor is adapted to perform the authentication of the received transaction order, in particular of the first and second transaction data, and is preferably also adapted to send an authentication signal to the payment management system.

5. Assembly as claimed in claim 4, wherein the payment terminal is adapted to perform an additional authentication, in particular of the first and second transaction data, and is preferably also adapted to send an authentication signal to the payment management system.

6. Assembly as claimed in claim 1, further comprising of:
storing on a storage medium of the payment management system (PMS) a transaction certificate (TC) for each of the performed transactions, wherein the transaction certificate comprises merchant-specific identification data concerning the relevant transaction.

7. Assembly as claimed in claim 6, comprising a communication unit (merchant portal) linked to the storage medium for providing external access to one or more of the transaction certificates (TCs).

8. System for performing a multiple authentication for a transaction between at least one merchant and at least one consumer, the system comprising:
a payment management system adapted to receive a first authentication signal representative of the result of a first authentication step on the basis of the PIN and PAN codes of the consumer, and to receive a second authentication signal representative of the telephone number of the consumer;
wherein the payment management system (PMS) further comprises a storage medium on which telephone data are prestored, and wherein the payment management system (PMS) is further adapted to perform a second authentication step on the basis of the second signal and the telephone data prestored on the storage medium.

9. System as claimed in claim 8, wherein the telephone data comprise the telephone numbers associated with the EMV SIM elements for which transactions are permitted.

10. System as claimed in claim 8, wherein the telephone data comprise the telephone numbers associated with the EMV SIM elements for which transactions are not permitted.

11. System as claimed in claim 8, comprising a payment terminal provided with:
a reader for reading both the PAN code and data relating to the telephone number associated with an EMV SIM element in the mobile phone of the consumer;
a keyboard for receiving the PIN code of the consumer.

12. System for handling transactions between at least one merchant and at least one consumer, the system comprising:
at least one payment terminal for generating and sending an electronic transaction order, the transaction order at least comprising the transaction amount, first identification data relating to the bank account number of the consumer and second identification data relating to the identity of the consumer;
a payment system for electronic transfer of the transaction amount from the bank account of the consumer to the bank account of the merchant;
a transaction order processor connected to the payment system for electronic clearing and settlement of the transaction amount associated with the transaction order, wherein the processor is adapted to perform an authentication on the basis of the first and second identification data and to generate a first authentication signal representative of the result of the authentication;
a payment management system (PMS) arranged between the payment terminal and the transaction order processor and comprising a storage medium on which telephone data are stored, wherein the payment management system is adapted:
to receive the first authentication signal; and
to receive a second authentication signal representative of the telephone number of the consumer; and
to perform a second authentication step on the basis of the second authentication signal and the telephone data prestored on the storage medium.

13. System as claimed in claim 12, wherein the payment terminal comprises:
a read unit for reading the first identification data, which are stored on an electronic input carrier and which are representative of the bank account of the consumer;
an input unit for entry by the consumer of the second identification data representative of the identity of the consumer.

14. System as claimed in claim 12, wherein the input carrier comprises a SIM card with EMV functionality.

15. System as claimed in claim 12, further comprising a separate first communication connection between the payment terminal and the payment management system and a second communication connection between the input carrier and the payment management system, preferably a mobile telephone connection.

16. System as claimed in claim 12, wherein the payment management system is linked via one or more communication connections to one or more transaction order processors.

17. System as claimed in claim 12, wherein a payment system comprises:
an issuer bank subsystem which manages the bank account of the consumer; and
an acquirer bank subsystem which manages the bank account of the merchant;
wherein a transaction order processor is adapted to control both subsystems for the purpose of transferring an amount of money from the issuer bank subsystem to the acquirer bank subsystem.

18. System as claimed in claim 12, wherein the payment terminal is a Point of Sale (POS) terminal.

19. System as claimed in claim 12, wherein the payment terminal comprises a wireless receiver for reading a smart card via a wireless connection, in particular a mobile telephone smart card, more particularly an EMV SIM card.

20. Method for handling transactions between at least one merchant and at least one consumer, wherein the assembly as claimed in claim 1 is applied.

21. Payment management system as defined in claim 1.
